(19) United States
(12) Patent Application Publication
(10) Pub. No.: US 2013/0130141 A1
(43) Pub. Date: May 23, 2013

(54) DIRECT OXIDATION FUEL CELL SYSTEM

(71) Applicants: Hiroaki Matsuda, Osaka (JP); Takashi Akiyama, Osaka (JP); Isamu Kawata, Osaka (JP)

(72) Inventors: Hiroaki Matsuda, Osaka (JP); Takashi Akiyama, Osaka (JP); Isamu Kawata, Osaka (JP)

(73) Assignee: PANASONIC CORPORATION, Osaka (JP)

(21) Appl. No.: 13/813,822

(22) PCT Filed: Apr. 12, 2012
(86) PCT No.: PCT/JP2012/002544

§ 371 Date: Feb. 1, 2013

(30) Foreign Application Priority Data
Jul. 19, 2011 (JP) 2011-157446
Jul. 28, 2011 (JP) 2011-164971

(51) Int. Cl. H01M 8/04

(52) U.S. Cl. CPC H01M 8/04201; H01M 8/04223
USPC 429/429

(57) ABSTRACT

Disclosed is a direct oxidation fuel cell system including: a direct oxidation fuel cell including an anode and a cathode, an air pump for supplying air to the cathode, a liquid feed pump for supplying an aqueous fuel solution to the anode, and a collection tank for collecting an anode fluid discharged from the anode. The collection tank has an anode fluid collection port at which the anode fluid is merged with a liquid in the collection tank. Either during normal operation or during suspension of operation of the fuel cell system, or both, the volume of the liquid in the collection tank is controlled to be equal to or greater than a predetermined first lower-limit value. The first lower-limit value is set such that the anode fluid collection port is positioned below the level of the liquid in the collection tank.

### TECHNICAL FIELD

The present invention relates to direct oxidation fuel cells, and particularly relates to the structure of a fuel cell equipped with a collection tank for collecting a fluid discharged from the anode, and the control of the liquid volume in the collection tank.

### BACKGROUND ART

As the performance of mobile devices such as cellular phones, notebook personal computers, and digital cameras improves, solid polymer fuel cells utilizing a solid polymer electrolyte membrane have been expected to be used as power sources for such devices. Among solid polymer fuel cells (hereinafter simply referred to as “fuel cells”), direct oxidation fuel cells, which operate on a liquid fuel such as methanol directly supplied to the anode, are suitable for size and weight reduction, and are being developed as a power source for mobile devices and a portable power generator.

Fuel cells include a membrane electrode assembly (MEA). The MEA is composed of an electrolyte membrane, an anode (fuel electrode) bonded to one surface of the electrolyte membrane, and a cathode (air electrode) bonded to the other surface thereof. The anode comprises an anode catalyst layer and an anode diffusion layer, and the cathode comprises a cathode catalyst layer and a cathode diffusion layer. The MEA is sandwiched between a pair of separators, forming a cell. The anode-side separator has a fuel flow channel for supplying fuel such as hydrogen gas or methanol to the anode. The cathode-side separator has an oxidant flow channel for supplying oxidant such as oxygen gas or air to the cathode. Two or more cells are electrically stacked in series, forming a stack.

From the direct oxidation fuel cell stack, liquid including water is discharged during power generation. From the cathode, water produced by power generation reaction is discharged, and from the anode, excess of aqueous fuel solution is discharged. The fuel of the direct oxidation fuel cell is oxidized at the anode, and the oxidation reaction requires water. Therefore, the fuel is usually mixed with water and supplied to the anode as an aqueous fuel solution. The amount thereof supplied to the anode is usually larger than the theoretically required amount of fuel calculated from the generation current, and hence, unreacted aqueous fuel solution is discharged from the fuel cell stack.

Discharging such fluid as it is from a fuel cell system is not good. In view of this, a fuel cell system provided with a mechanism for collecting liquid discharged from a fuel cell stack is proposed. The system includes a water collection tank for storing liquid collected, and the liquid in the water collection tank is treated by, for example, being vaporized and dissipated, being transferred to a tank for spent fuel, or being mixed with fuel and recycled as an aqueous fuel solution.

In the fuel cell system in which the liquid in the water collection tank is mixed with fuel and supplied as an aqueous fuel solution to the anode, since water produced during power generation is recycled, the liquid in the water collection tank will not increase continuously. In addition, since fuel is mixed with water within the fuel cell system, the fuel concentration in the fuel tank can be set higher than the fuel concentration of the aqueous fuel solution supplied to the anode. The fuel tank can be made smaller in size, and accordingly, the size and weight of the fuel cell system can be reduced.

As for fuel cells, the output thereof gradually decreases as cumulative power generation time increases. Fuel cells are required to maintain their output for a total of 40,000 hours or more when used as a power source for household use, and for a total of 5,000 hours or more when used as a power source for mobile devices or a portable power generator. Realization of such life characteristics requires various techniques.

The decrease in output associated with increase in cumulative power generation time is attributed to several causes, one of which is deterioration of the anode catalyst layer. The anode catalyst is, for example, a PtRu black catalyst being fine particles of alloy of platinum (Pt) and ruthenium (Ru), or a PtRu/C catalyst being carbon (C) particles supporting PtRu alloy fine particles. The anode catalyst layer further includes a polymer electrolyte with ion conductivity. It has been reported that in the anode catalyst layer after power generation for a long period of time, the occurrence of leaching of Pt and Ru, corrosion of carbon, decomposition of the polymer electrolyte, and the like is observed. Such occurrence deteriorates the anode performance and decreases the output.

It also has been reported that Ru leached out of the anode permeates through the electrolyte membrane, and deposits on the cathode. This deteriorates the cathode performance because Ru acts to reduce the activity of the Pt catalyst in the cathode.

Such deterioration of the anode catalyst layer has been reported to be accelerated by the increase in anode potential. In short, in order to improve the life characteristics of the fuel cell, the anode potential should be kept constantly low.

Moreover, countermeasures against long-term storage should be taken for systems utilizing a direct oxidation fuel cell. There may be a case where, depending on the user or application, the direct oxidation fuel cell is kept stored without being used for a long period of time. Even after such long-term storage, the direct oxidation fuel cell is required to maintain its performance as a fuel cell.

Possible changes that occur in the direct oxidation fuel cell due to long-term storage are considered to be attributable to some factors. One of them is dissipation of water from the fuel cell system. The oxidation reaction of fuel at the anode requires water. However, in a fuel cell system in which liquid in the water collection tank is mixed with fuel into an aqueous fuel solution, it may happen that the liquid in the water collection tank is dissipated during long-term storage, failing to supply an aqueous fuel solution having an appropriate concentration to the anode.

In general, supplying an aqueous fuel solution with high concentration deteriorates the power generation characteristics of the fuel cell stack, and after long-term storage, the fuel cell stack cannot exhibit sufficient performance. In addition to the temporal deterioration in performance, supplying an aqueous fuel solution with high concentration may cause a great expansion of the polymer electrolyte used in the MEA, which can be a cause of irreversible deterioration such as deformation or separation of each layer in the MEA. This may deteriorate the life characteristics of the MEA. Moreover, in the case of supplying water-free fuel only from the fuel tank, the fuel cell system becomes short of water, and as a result, the oxidation reaction at the anode does not occur, making it impossible to start the power generation of the fuel cell stack.

As described above, if water is dissipated from the fuel cell system due to long-term storage, the performance of the fuel cell system would deteriorate significantly. Therefore, water should be always held in the fuel cell system even when left unused for a long period of time.

Patent Literatures 1 and 2 propose a fuel cell system employing a mechanism in which, during power generation of the fuel cell, the amount of liquid collected from the fuel cell stack is controlled such that the amount of liquid in the collection tank is kept within a predetermined range.

Patent Literature 3 proposes a fuel cell system employing a mechanism in which, at startup of the fuel cell, when a long period of time has passed since the last use, the electrolyte membrane is moisturized.

### CITATION LIST

### Patent Literature

[PTL 1] Japanese Laid-Open Patent Publication No. 2006-086111
[PTL 2] Japanese Laid-Open Patent Publication No. 2006-107786
[PTL 3] Japanese Laid-Open Patent Publication No. 2005-243568

### SUMMARY OF INVENTION

### Technical Problem

For improving the life characteristics of a direct oxidation fuel cell, it is necessary to keep the anode potential constantly low; however, the inventors have found that the anode potential might be increased through the following mechanism, while the power generation is suspended.

At the moment when the power generation is stopped, the space volume at the anode is almost full of gases such as carbon dioxide (CO₂) generated by power generation reaction. As the temperature of the fuel cell decreases due to suspension of power generation, the volume of these gases shrinks significantly. The aqueous fuel solution remaining in the anode gradually permeates through the electrolyte membrane into the cathode, where the fuel reacts with oxygen remaining in the cathode and is consumed. This phenomenon is called “crossover of fuel”, and when the fuel is methanol, it is called “methanol crossover (MCO)”.

Specifically, while the power generation is suspended, the volume of gasses and liquids filled in the space volume at the anode gradually decreases. At this time, if the anode-side space in the stack is an enclosed space that does not communicate with outside air except through a fluid outlet of the anode, and only the fluid outlet of the anode is open to outside air, oxygen would intrude into the anode therethrough. This could be a cause of an increase in anode potential during the suspension, and repetitive increase and decrease of the anode potential due to repetitive power generation and its suspension could cause the deterioration as mentioned above to be accelerated.

It has been reported that, upon increase in anode potential due to the intrusion of oxygen, Ru leaches out of an alloy catalyst (Pt—Ru) of platinum (Pt) and ruthenium (Ru), which is usually used as an anode catalyst. The leaching of Ru reduces the activity of the anode catalyst.

On the other hand, in order to maintain the power generation characteristics of the fuel cell system after long-term storage, as well as to suppress the deterioration of the MEA, it is required to suppress the dissipation of water from the fuel cell system during storage.

One possible method for suppressing the intrusion of oxygen through the fluid outlet of the anode during suspension of power generation, and suppressing the dissipation of water during long-term storage is to provide a valve in a portion where the fuel cell power generation unit communicates with outside air, so that the valve is closed while the operation of the fuel cell is suspended. However, in this method, the whole or a part of the fuel cell power generation unit becomes a completely enclosed space. If the volume of gases and liquids in the fuel cell power generation unit changes with changes in temperature, the enclosed space will be a high-pressure space or a low-pressure space. Such great changes in pressure apply a load to the MEA, pipes, pumps, and the like, which may result in, for example, breakage of the electrolyte membrane or pipes, or malfunction of pumps.

In a method of performing a processing at startup of the fuel cell for suppressing dissipation of water, when the user wants to use the fuel cell system, it takes a certain period of time before the normal power generation starts. This requires the user to wait for the startup, which would impair the convenience. In addition, in the case where the startup of the fuel cell system is emergently required, the needs of the user would not be satisfied.

Another possible method is to judge the degree of dissipation of water on the basis of the length of storage duration. However, the correlation between the storage duration and the degree of dissipation of water is greatly dependent on the temperature and humidity during storage. As such, the degree of dissipation of water might be erroneously judged.

### Solution to Problem

One aspect of the present invention relates to a direct oxidation fuel cell system including a fuel cell including an anode and a cathode, an air pump for supplying air to the cathode, a liquid feed pump for supplying an aqueous fuel solution to the anode, and a collection tank for collecting an anode fluid discharged from the anode. The collection tank has an anode fluid collection port at which the anode fluid is merged with a liquid in the collection tank. Either during normal operation or during suspension of operation of the fuel cell system, or both, the volume of the liquid in the collection tank is controlled to be equal to or greater than a predetermined first lower-limit value. The first lower-limit value is set such that the anode fluid collection port is positioned below the level of the liquid in the collection tank.

Another aspect of the present invention relates to a direct oxidation fuel cell system including a fuel cell including an anode and a cathode, an air pump for supplying air to the cathode, a liquid feed pump for supplying an aqueous fuel solution to the anode, and a collection tank for collecting an anode fluid discharged from the anode. The collection tank has an anode fluid collection port at which the anode fluid is merged with a liquid in the collection tank. After the normal operation of the fuel cell system is stopped, the liquid in the collection tank is suctioned into an anode-side space extending from the liquid feed pump via the anode to the liquid in the collection tank.

### Advantageous Effects of Invention

According to the present invention, during suspension of operation of the fuel cell system, as the volume of the gases and liquids having filled the anode-side space decreases, the liquid in the collection tank flows into the anode-side space through the anode fluid collection port. As such, oxygen in the air is unlikely to intrude into the anode during suspension of power generation. Since the liquid in the collection tank includes an aqueous fuel solution, the flowing of this liquid into the anode allows the anode potential to be kept low. As a result, deterioration such as catalyst leaching can be suppressed, and the life characteristics of the fuel cell can be improved.

Furthermore, even in the case where the fuel cell system is kept stored without being used for a long period of time, a necessary amount of liquid for startup of the fuel cell system can be held in the collection tank. Accordingly, the user can store the fuel cell system for a long period of time, without concern for maintenance. In addition, at startup of the fuel cell system, the user need not wait for the volume and concentration of the liquid in the collection tank to be appropriate values. Moreover, during normal operation and during suspension of operation of the fuel cell system, the user need not replenish the collection tank with water. Therefore, the convenience of the user significantly improves.

### BRIEF DESCRIPTION OF DRAWINGS

FIG. 1 A schematic cross-sectional view of a unit cell of a direct oxidation fuel cell according to one embodiment of the present invention

FIG. 2 A schematic illustration of a direct oxidation fuel cell system according to one embodiment of the present invention

FIG. 3 A schematic illustration of a direct oxidation fuel cell system according to another embodiment of the present invention

FIG. 4 A schematic illustration of a direct oxidation fuel cell system according to yet another embodiment of the present invention

### DESCRIPTION OF EMBODIMENTS

A direct oxidation fuel cell system of the present invention includes a direct oxidation fuel cell (e.g., direct methanol fuel cell (DMFC)) including an anode and a cathode, an air pump for supplying air to the cathode, a liquid feed pump for supplying an aqueous fuel solution to the anode, and a collection tank for collecting an anode fluid discharged from the anode (usually, liquid including water, carbon dioxide, and unused fuel) through an anode fluid collection port. Either during normal operation or during suspension of operation of the fuel cell system, or both, the volume of the liquid in the collection tank is controlled to be equal to or greater than a predetermined first lower-limit value.

The first lower-limit value is set such that either during normal operation or during suspension of operation of the fuel cell system, or both, the anode fluid collection port is positioned below the liquid level of the collection tank in the direction of gravity.

According to the above configuration, normally, the anode fluid collection port is always kept closed with liquid. As such, after the normal operation of the fuel cell system is stopped, when the pressure in an anode-side space extending from the liquid feed pump via the anode to the liquid in the collection tank is about to decrease, the liquid in the collection tank is suctioned into the anode-side space. Therefore, oxygen in the air is unlikely to intrude into the anode, while the power generation is suspended.

The anode fluid collection port can be a through-hole communicating with the anode and being provided in the wall (e.g., the side or bottom) of the collection tank. Alternatively, the anode fluid collection port can be an opening provided on a piping in communication with the anode being, for example, inserted into the liquid in the collection tank, so that the anode fluid flows out therethrough. In the case where two or more through-holes or openings are provided, it suffices if the uppermost through-hole or opening in the direction of gravity is positioned below the liquid level of the collection tank.

The direct oxidation fuel cell system of the present invention is preferably configured such that the anode fluid can be entirely collected in the collection tank.

When the volume of the liquid in the collection tank is equal to the first lower-limit value, the volume of the liquid present above the anode fluid collection port is desirably greater than the volume of the anode-side space extending from the liquid feed pump via the anode to the anode fluid collection port in the liquid in the collection tank. By controlling like this, after the normal operation of the fuel cell system is stopped, almost the entire anode-side space can be easily filled with liquid. Filling almost the entire anode-side space with liquid can prevent the anode from becoming in a negative pressure state. Therefore, no additional load is applied to the MEA and the fuel pump, and the system malfunction can be prevented.

The direct oxidation fuel cell system of the present invention is desirably configured such that during suspension of operation, when the volume of the liquid in the collection tank reaches the first lower-limit value, an auxiliary operation is automatically performed for a certain period of time. Alternatively, it may configured such that during suspension of operation, when the volume of the liquid in the collection tank reaches a second lower-limit value different from the first lower-limit value, an auxiliary operation is automatically performed for a certain period of time. In other words, the lower-limit value may be set in one step or in two or more steps.

In the case where an auxiliary operation is supposed to be performed, the collection tank is desirably provided with a cathode fluid collection port for collecting at least part of the cathode fluid discharged from the cathode.

The reactions at the anode and cathode of a direct methanol fuel cell (DMFC) system are shown below. Oxygen introduced into the cathode is generally derived from the air.

Anode: CH₃OH+H₂O→CO₂+6H⁺+6e⁻

Cathode: (3/2)O₂+6H⁺+6e⁻→3H₂O

At the anode, methanol reacts with water, to produce carbon dioxide. Fuel effluent including carbon dioxide and unreacted fuel is sent to an effluent tank. On the other hand, at the cathode, water is produced in an amount greater than that consumed at the anode. By performing an auxiliary operation to allow part of water produced at the cathode to be collected in the collection tank, the volume of the liquid in the collection tank can be increased.

At least the second lower-limit value is set such that a necessary minimum amount of liquid can be held in the collection tank when the normal operation of the fuel cell system is started. The first lower-limit value is desirably set such that the volume of the liquid present above the anode fluid collection port is greater than the volume of the anode-side space, whereas the second lower-limit value may be set smaller than this.

Even during suspension of operation of the fuel cell system, since an auxiliary operation is automatically performed when the volume of the liquid in the collection tank falls below a predetermined value, the liquid in the collection tank will not be completely dissipated even in the case where the fuel cell system is stored without being used for a long period of time. If a certain amount or more of liquid is constantly held in the collection tank, every time at startup, an aqueous fuel solution having an appropriate concentration can be supplied to the anode. In other words, neither power generation using an aqueous fuel solution with high concentration, nor power generation using a fuel that does not contain water will occur. Therefore, the MEA is free of unnecessary deterioration factor, and the life characteristics can be improved.

In the present invention, the “normal operation” means operation other than an auxiliary operation. Unlike the auxiliary operation performed only for the purpose of increasing the volume of the liquid in the collection tank, the “normal operation” means operation for supplying power to an external load device. The “operation” means a running state of the fuel cell system, accompanied by power generation of the fuel cell. The “during suspension of operation” also means “during suspension of power generation”.

The fuel cell system may be equipped with a liquid volume sensing means for sensing the liquid volume in the collection tank, and an operation control means for controlling an operating state of the fuel cell system. In this case, the operation control means can control the normal operating state or auxiliary operating state of the fuel cell system on the basis of the liquid volume sensed by the liquid volume sensing means. By appropriately controlling the normal operating or auxiliary operating state, the volume of the liquid in the collection tank can be increased or decreased.

The direct oxidation fuel cell system of the present invention is preferably configured such that at least part of the cathode fluid can be collected in the collection tank. Accordingly, the collection tank is preferably provided with a cathode fluid collection port for collecting at least part of the cathode fluid discharged from the cathode.

The liquid volume sensing means is preferably a water level sensor capable of directly sensing the volume of liquid in the collection tank. This allows for accurate sensing of the degree of dissipation of water, under any temperature and humidity, and makes it easy to constantly keep the volume of the liquid in the collection tank equal to or higher than a certain level.

For the operation control means, an information processor such as a microcomputer can be used. An information processor comprises, for example, an arithmetic unit, a memory unit, and various interfaces, and the arithmetic unit performs an arithmetic operation necessary for normal operation or auxiliary operation, according to the program stored in the memory unit, and outputs a command necessary for controlling the output of each component of the fuel cell system. For example, the memory unit stores the relationship between a volume of the liquid collected in the collection tank (variable Y) and parameters (X₁, X₂ . . . Xₙ) regarding the output of each component of the fuel cell system. The arithmetic unit can output the parameters associated with the variable Y.

The fuel cell system may further include at least one selected from the group consisting of: (i) a combination of a fuel tank for accommodating fuel to be mixed with the liquid in the collection tank, and a fuel pump for supplying the fuel from the fuel tank to the liquid in the collection tank (or to the liquid to be supplied therefrom to another place in the system); (ii) a combination of an anode-side radiator through which the anode fluid passes, and an anode-side radiator cooling fan for cooling the anode-side radiator; (iii) a cathode-side radiator through which the cathode fluid passes, and a cathode-side radiator cooling fan for cooling the cathode-side radiator; and a stack cooling fan for cooling the fuel cell.

It suffices if the operation control means controls, on the basis of the liquid volume sensed by the liquid volume sensing means, at least one selected from the group consisting of: electric power generated by the fuel cell, output (flow rate) of the air pump, output (flow rate) of the liquid feed pump, output (flow rate) of the fuel pump, output (flow rate) of the anode-side radiator cooling fan, output (flow rate) of the cathode-side radiator cooling fan, and output (flow rate) of the stack cooling fan. As described above, by utilizing the operation control means and the liquid volume sensing means, the volume of the liquid in the collection tank can be controlled as desired.

In the direct oxidation fuel cell system, when the liquid volume in the collection tank is sensed as being below the first lower-limit value during its normal operation, a warning for urging replenishment of water to the collection tank is desirably outputted. Furthermore, in the fuel system, when the volume of the liquid in the collection tank is sensed as being still below the first or second lower-limit value even after the auxiliary operation for a certain period of time, a warning for urging replenishment of water to the collection tank is desirably outputted.

Specific embodiments of the present invention are described below with reference to appended drawings.

### Embodiment 1

A direct oxidation fuel cell system according to this embodiment includes a direct oxidation fuel cell (fuel cell stack) including an anode and a cathode, an air pump for supplying air to the cathode, a liquid feed pump for supplying an aqueous fuel solution to the anode, and a collection tank for collecting at least an anode fluid discharged from the anode. The anode fluid is configured to enter at a position below the liquid level of the collection tank. The anode-side space is a space extending from the liquid feed pump to a point where it merges with the liquid in the collection tank, and is an enclosed space. In the fuel cell system according to this embodiment, the volume of the liquid in the collection tank is controlled to be equal to or greater than a predetermined first lower-limit value, so that at least part of or preferably all of the anode-side space is filled with the liquid, when the anode-side space falls in a reduced-pressure state.

A cell 1 of FIG. 1 has a membrane electrode assembly (MEA) 5 including an anode 2, a cathode 3, and an electrolyte membrane 4 interposed between the anode 2 and the cathode 3. On one side surface of the MEA 5, a gasket 14 is disposed to seal the anode 2, and on the other side surface, a gasket 15 is disposed to seal the cathode 3.

The MEA 5 is sandwiched between an anode-side separator 10 and a cathode-side separator 11. The anode-side separator 10 is in contact with the anode 2, and the cathode-side separator 11 is in contact with the cathode 3. The anode-side separator 10 has a fuel flow channel 12 for supplying fuel to the anode 2. The fuel flow channel 12 has an anode inlet through which fuel enters the anode, and an anode fluid outlet through which CO₂ as a reaction product and unused fuel are discharged. The cathode-side separator 11 has an oxidant flow channel 13 for supplying oxidant to the cathode 3. The oxidant flow channel 13 has a cathode inlet through which the oxidant enters the cathode, and a cathode fluid outlet through which water as a reaction product and unused oxidant are discharged.

A stack is formed by providing two or more unit cells as illustrated in FIG. 1 and electrically stacking them in series. In this case, the anode-side and cathode-side separators 10 and 11 are usually integrally formed as one separator. Specifically, one surface of one separator has an anode-side separator and the other surface has a cathode-side separator. The anode inlets of the unit cells are usually joined together into one, using, for example, a manifold. The anode fluid outlets, the cathode inlets, and the cathode fluid outlets are respectively joined in the similar manner.

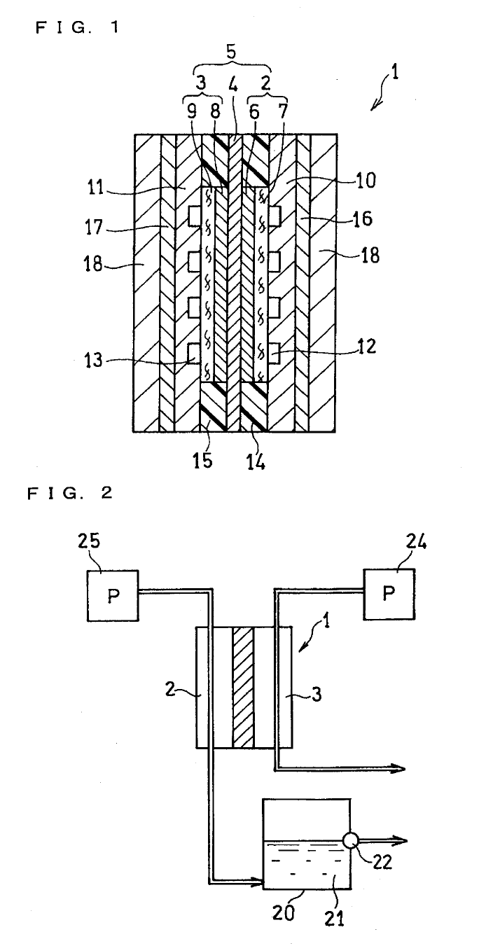

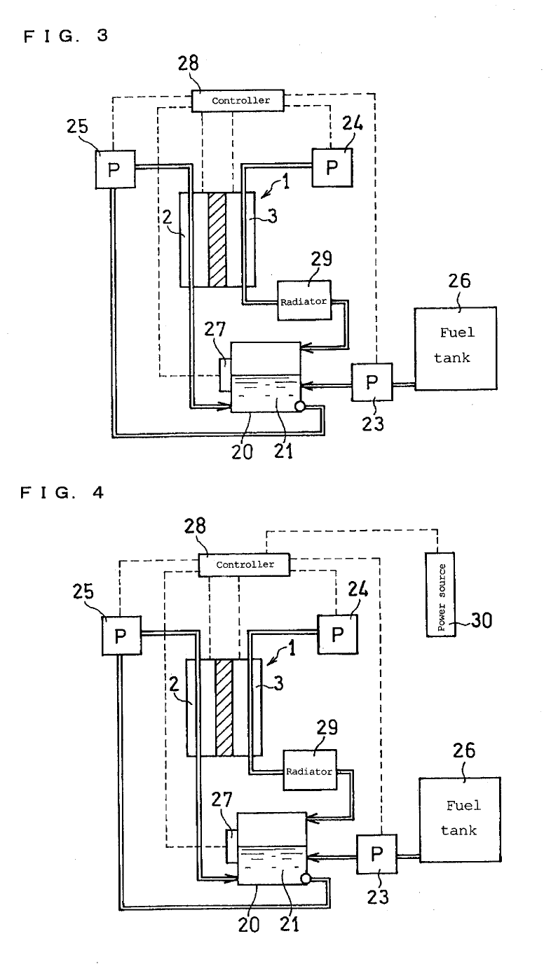

Direct oxidation fuel cell systems of FIGS. 2 and 3 have a collection tank 20 for collecting at least an aqueous fuel solution discharged from the anode 2 of the fuel cell stack. In the collection tank 20, a liquid 21 including an aqueous fuel solution discharged from the anode 2 is stored. The anode fluid from the anode fluid outlet of the stack is configured to flow into the liquid in the collection tank 20 via a tube or the like. In the case of inserting a tube into the liquid, the opening at the end of the tube serves as the anode fluid collection port. The anode fluid collection port is provided at the bottom or the side near the bottom of the collection tank 20 so that the anode fluid can reliably flow into the liquid.

In order to prevent the intrusion of oxygen into the anode 2 during suspension of operation of the fuel cell, the anode-side space in the fuel cell system, i.e., the space extending from a liquid feed pump 25 via the anode to the liquid in the collection tank, is made an enclosed space. The anode 2 of the MEA 5 is sealed with the gasket 14 so that it does not communicate with outside except through the anode inlet and the anode fluid outlet.

Preferably, during normal operation of the fuel cell system, the volume of the liquid 21 in the collection tank is controlled to be greater than the volume of the anode-side space. Since the anode fluid collection port is provided near the bottom of the collection tank, the anode fluid collection port will be always positioned below the liquid level of the collection tank during normal operation of the fuel cell system. Moreover, since the volume of the liquid 21 in the collection tank is greater than the volume of the anode-side space, almost all of the anode-side space can be filled with liquid.

The volume of the anode-side space includes, although depending on the configuration of the fuel cell system, for example, the capacity of the fuel flow channel 12, the capacity of the manifold serving as the anode inlet or the anode fluid outlet, the capacity of the connection piping from the liquid feed pump 25 to the manifold on the anode-inlet side, and from the manifold on the anode-fluid outlet side to the anode fluid collection port in the liquid 21 in the collection tank, and the pore capacity of the anode 2 which is usually porous. Since the volume of the liquid 21 in the collection tank is controlled to be greater than the volume of the anode-side space, oxygen is unlikely to intrude into the anode 2 through the anode fluid outlet, while the operation of the fuel cell is suspended.

Rather than being set slightly greater than the volume of the anode-side space, the volume of the liquid 21 in the collection tank is desirably set sufficiently large so that shortage of the liquid 21 will not occur. This is because the liquid 21 having flown from the collection tank into the anode 2 during suspension of operation of the fuel cell is considered to permeate through the electrolyte membrane 4 into the cathode 3.

In the case where the anode fluid collection port is not provided near the bottom of the collection tank, much of the liquid 21 in the collection tank might remain in the collection tank 20 when the operation is stopped, without being suctioned into the anode-side space. In this case, the lower-limit value of the liquid 21 in the collection tank is desirably set to be sufficiently greater than the volume of the anode-side space. However, if the liquid 21 in the collection tank is too much, the resistance when allowing the anode fluid to flow into the collection tank 20 by hydraulic pressure becomes high. If the flow of the anode fluid is slowed, this may affect the power generation characteristics.

Specifically, the first lower-limit value of the volume of the liquid 21 in the collection tank is preferably set to be 1.5 to 5 times as much as the volume of the anode-side space, and particularly preferably set such that the volume of the liquid present above the anode fluid collection port is 1.5 to 5 times as much as the volume of the anode-side space.

The capacity of the collection tank 20 is determined with taking into account the volume of the liquid 21 necessary for smooth operation of the fuel cell system. The collection tank 20 may have a large capacity; however, if the capacity is too large, the entire fuel cell system becomes large in volume, accordingly. In view of the volumetric efficiency, the capacity of the collection tank 20 is preferably set to be about 1.5 to 5 times as much as the volume of the liquid 21 in the collection tank corresponding to the first lower-limit value (the volume larger than that of the anode-side space).

FIG. 2 is a schematic illustration of a configuration of the fuel cell system according to this embodiment. To the cathode 3 of the fuel cell, air is supplied by an air pump 24, and to the anode 2 of the fuel cell, fuel is supplied by a liquid feed pump 25. The liquid 21 discharged from the anode side is collected into the collection tank 20. Of the liquid 21 stored in the collection tank 20, excess liquid is discharged through a drain 22. In such a configuration, the volume of the liquid 21 in the collection tank is determined according to the position of the drain 22. In other words, the drain 22 functions as a liquid volume control means for controlling the liquid volume in the collection tank. This configuration is based on the assumption that the liquid 21 in the collection tank does not decrease during power generation.

FIG. 3 is a schematic illustration of another configuration of the fuel cell system according to this embodiment. This fuel cell system is configured such that the liquid 21 in the collection tank 20 is mixed with fuel, and then supplied as an aqueous fuel solution to the anode 2. In the fuel cell system of FIG. 3, at least part of cathode fluid discharged from the cathode 3 flows into the collection tank 20. Fuel is supplied from a fuel tank 26 to the collection tank 20 by a fuel pump 23, to adjust the fuel concentration of the liquid 21 in the collection tank 20. The aqueous fuel solution whose concentration has been adjusted is supplied from the collection tank 20 to the anode 2 of the fuel cell stack by the liquid feed pump 25. Separately from the collection tank 20, an auxiliary tank for mixing the liquid 21 with fuel to prepare an aqueous fuel solution may be provided. Alternatively, the piping from the fuel tank 26 via the fuel pump 23 may be joined with the piping from the collection tank 20 to the liquid feed pump 25.

In the fuel cell system as illustrated in FIG. 3, since the water produced during power generation is recycled, the volume of the liquid 21 in the collection tank can be easily controlled. Furthermore, since the liquid 21 in the collection tank does not flow out of the fuel cell system through the drain, the convenience of the user improves. Moreover, since the fuel is mixed with the liquid in the collection tank within the fuel cell system, the concentration of fuel in the fuel tank 26 can be set high. By setting the fuel concentration high, the fuel tank 26 can be made compact. Therefore, the size and weight of the fuel cell system can be reduced.

Gases such as the CO₂ produced by power generation reaction at the anode 2 also flow into the collection tank 20. As such, in the case where the fuel cell system is not provided with a drain, the collection tank 20 is generally configured such that gas can pass through its upper portion, preferably its ceiling portion. For example, by providing an opening at the upper portion or the ceiling portion of the collection tank 20, and closing the opening with a porous thin film having gas permeability, gases such as CO₂ can be released outside through the porous thin film.

The fuel cell system of FIG. 3 is further equipped with a liquid volume sensing means 27 for sensing the volume of the liquid 21 in the collection tank, and an operation control means 28 for controlling the operating state of the fuel cell system. In the configuration in which the liquid 21 in the collection tank 20 is supplied to the anode 2, there is a possibility that the liquid 21 in the collection tank 20 gradually decreases during power generation. Therefore, in order to accurately control the volume of the liquid 21, it is desirable to detect the liquid 21 held in the collection tank.

Examples of the liquid volume sensing means 27 include various types of water level sensors, such as float-type, optical, ultrasonic, and capacitive water level sensors. However, when it is taken into account that the liquid 21 in the collection tank 21 can flow into the anode 2, a water level sensor that allows no metal ions to be leached into the liquid 21 in the collection tank is preferred, so that the performance of the MEA 5 is not affected.

The operation control means 28 controls the operating state of the fuel cell system, on the basis of the volume of the liquid 21 sensed by the liquid volume sensing means 27. Specifically, on the basis of the result sensed by the liquid volume sensing means 27, the normal operating state is controlled such that the liquid 21 in the collection tank is greater than the first lower-limit value (e.g., the volume of the anode-side space). In other words, in one aspect, the operation control means 28 functions as a part of the liquid volume control means for controlling the volume of the liquid in the collection tank. The liquid volume control means can be realized through organic cooperation of the operation control means 28 with various components constituting the fuel cell system.

During power generation of the fuel cell stack, the water produced by power generation reaction is discharged from the cathode 3, and the unused aqueous fuel solution is discharged from the anode 2. By allowing the liquid volume control means to control the collected volume of these liquids, the volume of the liquid 21 in the collection tank can be appropriately controlled. Such control can be automatically performed in the fuel cell system by the command from the operation control means 28.

By the command from the operation control means 28, for example, at least one selected from the group consisting of: electric power generated by the fuel cell 1, flow rate of the air pump 24, flow rate of the liquid feed pump 25, and flow rate of the fuel pump 23, is controlled. In this case, cooperation of the operation control means 28 and the fuel cell 1, cooperation of the operation control means 28 and the air pump 24, cooperation of the operation control means 28 and the liquid feed pump 25, and cooperation of the operation control means 28 and the fuel pump 23 each function as a part of the liquid volume control means (collected volume control means). Therefore, the operation control means 28 is connected to the liquid volume sensing means 27, the fuel cell 1, the air pump 24, the liquid feed pump 25, and the fuel pump 23.

Even though oxygen in the air enters the cathode 3 while the operation of the fuel cell 1 is suspended, this does not significantly affect the life characteristics. Therefore, it is not necessary to introduce the liquid 21 in the collection tank 20 into the cathode 3 while the operation of the fuel cell is suspended. In normal direct oxidation fuel cells, air is used as the oxidant, and therefore, most of the fluid discharged from the cathode 3 is nitrogen. If nitrogen is introduced into the liquid 21 in the collection tank 20, the liquid is bubbled, which causes noise or the like. Therefore, it is preferable to allow the cathode fluid to flow into the collection tank 20 from its upper portion, and allow the gases such as nitrogen to be immediately discharged outside.

Reducing the power generated by the fuel cell means a less amount of fuel required, which results in an increased amount of fluid discharged from the anode 2. Conversely, increasing the power generated by the fuel cell results in a decreased amount of fluid discharged from the anode 2.

Increasing the flow rate of the fuel pump 23 or decreasing the flow rate of the liquid feed pump 25 to raise the concentration of the aqueous fuel solution leads to increased fuel crossover, and as a result, the amount of water produced by the reaction between fuel and oxygen at the cathode 3 is increased. Increasing both the flow rates of the fuel pump 23 and the liquid feed pump 25 to increase the excess fuel still leads to increased fuel crossover.

Increasing the flow rate of the air pump 24 leads to increase in the amount of moisture to be lost from the fuel cell due to the flow of air, and as a result, the amount of moisture discharged from the cathode 3 is increased. Since the temperature of the fuel cell is higher than that of the air, the moisture contained in the cathode fluid condenses as it is discharged from the fuel cell. By allowing the condensed water to flow into the collection tank 20, water can be collected from the cathode fluid.

The fuel cell system of FIG. 3 includes a cathode-side radiator 29 through which the cathode fluid passes. At least part of the cathode fluid passes through the cathode-side radiator 29 and then flows into the collection tank 20. The cathode-side radiator 29 is cooled by a cathode-side radiator cooling fan (not shown). In this configuration, water contained in the cathode fluid can be condensed in a highly efficient manner, and therefore, a larger amount of water can be collected in the collection tank 20. The fuel cell system may be further equipped with an anode-side radiator through which the anode fluid passes, and an anode-side radiator cooling fan for cooling the anode-side radiator. It is to be noted that due to the necessity of making the anode-side space an enclosed space, the cathode fluid and the anode fluid cannot be distributed through the same route. In the case of allowing both fluids to pass through a radiator, two radiators for the cathode and anode must be provided. The fuel cell system may have only an anode-side radiator and a cooling fan therefor, without having a cathode-side radiator and a cooling fan therefor.

In the case where a radiator is provided, the operation control means 28 may control at least one selected from the group consisting of: flow rate of the anode-side radiator cooling fan, and flow rate of the cathode-side radiator cooling fan, on the basis of the volume of the liquid 21 sensed by the liquid volume sensing means 27. In this case, cooperation of the operation control means 28 and the anode-side radiator cooling fan, and cooperation of the operation control means 28 and the cathode-side radiator cooling fan each function as a part of the liquid volume control means (collected volume control means). Therefore, the operation control means 28 is connected to the anode-side radiator cooling fan and the cathode-side radiator cooling fan.

Increasing the flow rate of the radiator cooling fan lowers the temperature of the radiator, and as a result, the condensed amount of gaseous water and aqueous fuel solution contained in the fluid is increased. Therefore, a larger amount of liquid can be collected in the collection tank 20.

The fuel cell system may be further equipped with a stack cooling fan for cooling the fuel cell (fuel cell stack). At this time, the operation control means 28 can also control flow rate of the stack cooling fan, on the basis of the volume of the liquid 21 sensed by the liquid volume sensing means 27. Increasing the flow rate of the stack cooling fan lowers the temperature of the fuel cell, and as a result, the amount of gaseous water and aqueous fuel solution discharged from the fuel cell is decreased, while the amount of fluid discharged as droplets is increased. In this case, cooperation of the operation control means 28 and the stack cooling fan functions as a part of the liquid volume control means (collected volume control means).

By controlling the normal operating state as described above, the volume of the liquid in the collection tank can be efficiently controlled. The output of each component of the fuel cell system may be varied continuously or stepwise, depending on the volume of the liquid 21 in the collection tank. For example, the power generated by the fuel cell may be controlled in two steps depending on the volume of the liquid 21 in the collection tank. The volume of the liquid 21 is not necessarily controlled continuously, and it suffices if it is controlled stepwise. Stepwise control is preferable because it can be done more simply and the number of parts and cost of the fuel cell system can be easily reduced.

In the fuel cell system according to this embodiment, the volume of the liquid 21 in the collection tank is controlled to be equal to or greater than the first lower-limit value; however, in the event where operation control cannot be performed appropriately, such as in the event of an abnormality, it is assumed that the volume of the liquid 21 in the collection tank falls below the first lower-limit value. In such occasion, a warning for urging replenishment of water to the collection tank 20 is preferably outputted in a form recognizable by the user. The warning may be visually recognizable or audibly recognizable such as voice.

Next, each component of the direct oxidation fuel cell system is described with reference to FIG. 1. It is to be noted that each component is not limited to those described below.

The cathode 3 includes a cathode catalyst layer 8 in contact with the electrolyte membrane 4, and a cathode diffusion layer 9 in contact with the cathode-side separator 11. The cathode diffusion layer 9 includes, for example, an electrically conductive water-repellent layer in contact with the cathode catalyst layer 8, and a substrate layer in contact with the cathode-side separator 11.

The cathode catalyst layer 8 includes a cathode catalyst and a polymer electrolyte. The cathode catalyst is preferably a noble metal such as Pt with high catalytic activity. The cathode catalyst may be used with or without a support. The support is preferably a carbon material such as carbon black in view of its excellent electronic conductivity and acid resistance. The polymer electrolyte is preferably a proton conductive material such as a perfluorosulfonic acid polymer material or a hydrocarbon polymer material. Examples of the perfluorosulfonic acid polymer material include Nafion (registered trademark).

The anode 2 includes an anode catalyst layer 6 in contact with the electrolyte membrane 4, and an anode diffusion layer 7 in contact with the anode-side separator 10. The anode diffusion layer 7 includes, for example, an electrically conductive water-repellent layer in contact with the anode catalyst layer 6, and a substrate layer in contact with the anode-side separator 10.

The anode catalyst layer 6 includes an anode catalyst and a polymer electrolyte. The anode catalyst is preferably a PtRu alloy catalyst in view of reducing catalyst poisoning by carbon monoxide. The anode catalyst may be used with or without a support. The support may be a carbon material like that used for the cathode catalyst. The polymer electrolyte included in the anode catalyst layer 6 may be a material like that used for the cathode catalyst layer 8.

The conductive water-repellent layers included in the anode and cathode diffusion layers 7 and 9 each include a conductive material and a water repellent material. The conductive material included in the conductive water-repellent layer may be any conductive material such as carbon black as commonly used in the field of fuel cells. The water repellent material included in the conductive water-repellent layer may be any water repellent material such as polytetrafluoroethylene (PTFE) as commonly used in the field of fuel cells.

The substrate layer is made of a conductive porous material. The conductive porous material may be any conductive porous material such as carbon paper as commonly used in the field of fuel cells. These porous materials may contain a water repellent material so that the diffusion of fuel and the removal of product water can be improved. The water repellent material may be a material like that included in the conductive water-repellent layer.

The electrolyte membrane 4 may be, for example, any proton conductive polymer membrane conventionally used in the art. Preferable examples thereof include a perfluorosulfonic acid polymer membrane and a hydrocarbon polymer membrane. Examples of the perfluorosulfonic acid polymer membrane include Nafion (registered trademark).

The direct oxidation fuel cell of FIG. 1 can be produced, for example, by the following method. The MEA 5 is produced by bonding the anode 2 to one surface of the electrolyte membrane 4 and the cathode 3 to the other surface by, for example, hot pressing. The MEA 5 is then sandwiched between the anode-side separator 10 and the cathode-side separator 11. At this time, the gaskets 14 and 15 are disposed to seal the anode 2 and the cathode 3 of the MEA 5, respectively. Thereafter, the anode-side separator 10 and the cathode-side separator 11 are sandwiched between current collector plates 16 and 17, and between end plates 18 and 19, and they are clamped. In addition, a heater for temperature control may be laminated to the outsides of the end plates 18 and 19.

### Embodiment 2

A direct oxidation fuel cell system according to this embodiment includes a direct oxidation fuel cell (fuel cell stack) including an anode and a cathode, an air pump for supplying air to the cathode, a liquid feed pump for supplying an aqueous fuel solution to the anode, a collection tank for collecting a liquid including water and unused fuel from the fluid discharged from the fuel cell, a fuel tank, and a fuel pump for supplying fuel from the fuel tank. The liquid in the collection tank is mixed with the fuel supplied from the fuel tank, and then supplied as an aqueous fuel solution to the anode. The operating state of the fuel cell system is controlled by an operation control means. The volume of the liquid in the collection tank is sensed by a liquid volume sensing means.

In short, the basic configuration of the fuel cell system according to this embodiment is similar to that of the fuel cell system according to Embodiment 1 (e.g., an embodiment of FIG. 3). The configuration of the fuel cell is also similar to that of FIG. 1. Accordingly, the fuel cell system according to this embodiment may have the exactly same functions as the fuel cell system according to Embodiment 1.

The difference is that the fuel cell system of this embodiment is equipped with a power supply for supplying electric power to at least the liquid volume sensing means while the operation is suspended. During suspension of operation, when the liquid volume in the collection tank falls below a second lower-limit value, the operation control means commands the fuel cell system to automatically perform an auxiliary operation for a certain period of time. During auxiliary operation, liquid including water and unused fuel is collected from the fluid discharged from the fuel cell, whereby the liquid volume in the collection tank can be increased.

FIG. 4 is a schematic illustration of a configuration of the direct oxidation fuel cell system according to this embodiment. The same components are denoted by the same reference signs.

During suspension of operation, such as during long-term storage of the fuel cell system, dissipation of water held in the collection tank occurs. As such, even though the volume of the liquid 21 remaining in the collection tank is equal to or greater than the first lower-limit value at the time when the normal operation of the fuel cell system is stopped, it is predicted that in the fuel cell system during suspension of operation, the liquid 21 in the collection tank will gradually decrease. As a countermeasure therefor, in this embodiment, a power source 30 for supplying electric power to at least the liquid volume sensing means 27 during suspension of operation of the fuel cell system is provided, so that the liquid 21 in the collection tank can be monitored even during suspension of operation. The information sensed by the liquid volume sensing means 27 is periodically transmitted to the operation control means 28. When the volume of the liquid 21 in the collection tank falls below a second lower-limit value, the operation control means 28 automatically activates the fuel cell system. Upon activation, an auxiliary operation for increasing the volume of the liquid 21 in the collection tank is performed for a certain period of time. The auxiliary operation is automatically performed without requiring operation by the user.

Examples of the power source 30 for supplying power to at least the liquid volume sensing means 27 during suspension of operation of the fuel cell system include various chemical batteries such as dry batteries and lithium ion secondary batteries. Usually, in activating the fuel cell system, power needs to be supplied also to the components such as the air pump 24, liquid feed pump 25, and fuel pump 23. Therefore, the power source 30 for supplying power to the liquid volume sensing means 27 may be the same as that for supplying power to these components. The liquid volume sensing means 27 is preferably low in power consumption so that the liquid volume sensing means 27 is kept supplied with power even during long-term storage of the fuel cell system.

During auxiliary operation of the fuel cell system, from the cathode 3, water produced by the power generation reaction and by the reaction of the crossover fuel having permeated through the electrolyte membrane 4 is collected. From the anode 2, unused aqueous fuel solution is collected. By allowing the operation control means 28 to control the collected volume of liquids in a manner similar to in Embodiment 1, the volume of the liquid 21 in the collection tank can be increased to a predetermined value greater than the second lower-limit value.

The second lower-limit value of the liquid 21 in the collection tank may be determined as appropriate according to the configuration of the fuel cell system. It is to be noted, however, that the second lower-limit value should be at least greater than zero. The second lower-limit value is also set such that during suspension of operation of the fuel cell system, the anode fluid collection port is always positioned below the liquid level of the collection tank in the direction of gravity. This can prevent the entry of air into the anode-side space, even when the liquid volume in the collection tank varies greatly during suspension of operation.

In order to supply a sufficient amount of aqueous fuel solution to the anode of the fuel cell for activating the fuel cell system, the second lower-limit value, like the first lower-limit value in Embodiment 1, is preferably set such that the volume of the liquid present above the anode fluid collection port is 1.5 to 5 times as much as the volume of the anode-side space. In other words, when the anode fluid collection port is provided at the bottom or near the bottom of the collection tank, a volume 1.5 to 5 times as much as the volume of the anode-side space may be set as the second lower-limit value.

The first lower-limit value and the second lower-limit value may be different, but are preferably the same because the control of the fuel cell system can be simplified. In this case, during both normal operation and suspension of operation, the liquid volume in the collection tank can be maintained equal to or greater than a common lower-limit value.

In the auxiliary operation, the operation control means can control at least one selected from the group consisting of: electric power generated by the fuel cell, flow rate of the air pump, flow rate of the liquid feed pump, flow rate of the fuel pump, flow rate of the anode-side radiator cooling fan, flow rate of the cathode-side radiator cooling fan, and flow rate of the stack cooling fan, to be an output different from that in the normal operation. Specifically, the output of each component of the fuel cell system is controlled so that the liquid volume in the collection tank can be efficiently increased by the auxiliary operation in a short period of time. The conditions for normal operation are to control the output of each component of the fuel cell system such that the volume of the liquid 21 in the collection tank will not significantly increase or decrease, and therefore, may require a long time to increase the volume of the liquid 21 in the collection tank. Even when the power generation by the fuel cell is not performed, if such an auxiliary operation that causes fuel crossover is performed, water is produced at the cathode 3, and thus, water can be collected.

In the fuel cell system according to this embodiment, the volume of the liquid 21 in the collection tank is controlled to be equal to or greater than the first or second lower-limit value; however, for example, in the event of an abnormality, the volume of the liquid 21 in the collection tank might be still below the first or second lower-limit value, ever after the auxiliary operation for a certain period of time. In such occasion, a warning for urging replenishment of water to the collection tank 20 is preferably outputted in a form recognizable by the user. The warning may be visually recognizable or audibly recognizable such as voice. The warning may be followed by a motion to automatically stop the auxiliary operation.

The present invention is more specifically described below by way of Examples. The following Examples, however, are not to be construed as limiting the invention.

### Example 1

### (a) Formation of Cathode Catalyst Layer

A supported cathode catalyst including a cathode catalyst and a catalyst support for supporting the cathode catalyst was prepared. A Pt catalyst was used as the cathode catalyst. A carbon black (trade name: Ketjen black ECP, available from Ketjen Black International Company Ltd.) was used as the catalyst support. The weight ratio of Pt catalyst to the total weight of Pt catalyst and carbon black was 50 wt %.

A dispersion of the supported cathode catalyst in an aqueous isopropanol solution was mixed with a dispersion of Nafion (registered trademark) (5 wt % Nafion solution available from Sigma-Aldrich Japan K.K.) serving as a polymer electrolyte, to prepare an ink for forming a cathode catalyst layer. The ink for forming a cathode catalyst layer was applied onto a polytetrafluoroethylene (PTFE) sheet by doctor blade application, and dried to form a cathode catalyst layer.

### (b) Formation of Anode Catalyst Layer

A PtRu alloy catalyst (Pt:Ru=1:1 (atomic ratio)) was used as an anode catalyst. An anode catalyst layer was formed in the same manner as the cathode catalyst layer, except that the anode catalyst was used in place of the cathode catalyst. The weight ratio of PtRu catalyst to the total weight of PtRu catalyst and Ketjen black was 50 wt %.

### (c) Preparation of Paste for Forming Conductive Water-Repellent Layer

A dispersion of water repellent material and a conductive material were dispersed and mixed in ion-exchange water to which a predetermined surfactant had been added, to prepare a paste for forming a conductive water-repellent layer. A PTFE dispersion (PTFE content: 60 mass %, available from Sigma-Aldrich Japan K.K.) was used as the dispersion of water repellent material. Acetylene black (DENKA BLACK, available from Denki Kagaku Kogyo K.K.) was used as the conductive material.

### (d) Formation of Substrate Layer

A carbon paper (TGP-H-090, thickness: 270 μm, available from Toray Industries Inc.) was used as the conductive porous material constituting the anode substrate layer of the anode diffusion layer. The carbon paper was immersed in a PTFE dispersion (available from Sigma-Aldrich Japan K.K.) containing PTFE serving as a water repellent material, and dried. In this way, the carbon paper was made water-repellent.

A carbon cloth (AvCarb (registered trademark) 1071HCB, available from Ballard Material Products Inc.) was used as the conductive porous material constituting the cathode substrate layer of the cathode diffusion layer. This carbon cloth was also made water-repellent in the same manner as described above.

### (e) Formation of Anode Diffusion Layer and Cathode Diffusion Layer

The paste for forming a conductive water-repellent layer prepared in (c) was applied onto one side of the anode substrate layer formed in (d), and then dried to form an anode diffusion layer. Likewise, the paste for forming a conductive water-repellent layer prepared in (c) was applied onto one side of the cathode substrate layer formed in (d), and then dried to form a cathode diffusion layer.

### (f) Production of Membrane Electrode Assembly (MEA)

The cathode catalyst layer formed on the PTFE sheet in (a) was disposed on one side of an electrolyte membrane (trade name: Nafion (registered trademark) 112, available from E.I. Du Pont de Nemours & Co. Inc.), and the anode catalyst layer formed on the PTFE sheet in (b) was disposed on the other side of the electrolyte membrane. At this time, the cathode catalyst layer was disposed in contact with one side of the electrolyte membrane, and the anode catalyst layer was disposed in contact with the other side thereof. Thereafter, the cathode catalyst layer and the anode catalyst layer were bonded to the electrolyte membrane by hot pressing, and the PTFE sheets were removed from the cathode and anode catalyst layers.

Subsequently, the cathode diffusion layer was bonded to the cathode catalyst layer, and the anode diffusion layer was bonded to the anode catalyst layer, by hot pressing. In this way, a membrane electrode assembly (MEA) was produced.

### (g) Production of Fuel Cell

A rubber gasket was fitted to each side of the electrolyte membrane exposed at the periphery of the MEA, to cover the whole exposed portion of the electrolyte membrane. Subsequently, the MEA was sandwiched between an anode-side separator and a cathode-side separator. The anode-side separator had been provided with a fuel flow channel for supplying fuel, on its surface to be in contact with the anode. The cathode-side separator had been provided with an oxidant flow channel for supplying oxidant, on its surface to be in contact with the cathode. The flow channels were each formed in a serpentine shape. In this way, a unit cell of a direct oxidation fuel cell was obtained.

In a similar way, ten unit cells were produced in total, and stacked one after another. Subsequently, on the outside of each of the anode- and cathode-side separators positioned on both ends, a current collector plate, an insulator plate, and an end plate were disposed in this order. The resultant stack was clamped with predetermined clamping means. On the outside of each end plate, a heater for temperature adjustment was laminated. A manifold was attached to the cathode inlets of the cells, to join them into one. Likewise, manifolds were attached to the cathode fluid outlets, the anode inlets, and the anode fluid outlets of the cells, respectively, to join them into one. In this way, a direct oxidation fuel cell stack was obtained.

### (h) Production of Fuel Cell System

A mass flow controller was connected to the manifold joining the cathode inlets of the fuel cell stack produced in (g), and a resin tube was connected to the manifold joining the cathode fluid outlets. A liquid feed pump was connected to the manifold joining the anode inlets, and a resin tube was connected to the manifold joining the anode fluid outlets. The resin tube of the cathode fluid outlet was introduced into a waste liquid tank, and the resin tube of the anode fluid outlet was introduced into a collection tank.

The collection tank was a rectangular resin container with a capacity of 100 mL. First, 50 mL of ion-exchange water was poured into the collection tank, and then the opening (anode fluid collection port) of the resin tube of the anode fluid outlet was introduced until it contacted the bottom of the collection tank, to allow the fluid discharged from the anode to flow into the liquid in the collection tank. A drain was provided on the side surface of the collection tank at a position at which the volume of the liquid in the collection tank measured 50 mL, and a resin tube was connected thereto and introduced into the waste liquid tank. The resin tube of the cathode fluid outlet and the resin tube from the drain were introduced into the waste liquid tank from above. In this way, a direct oxidation fuel cell system of Example 1 was obtained. In this fuel cell system, the drain provided on the side surface of the collection tank constitutes a liquid volume control means.

The volume of the anode-side space in this fuel cell system as measured from the liquid feed pump to the anode fluid collection port in the liquid in the collection tank was 15 mL.

### Example 2

A fuel cell stack was produced in the same manner as in Example 1. A mass flow controller was connected to the manifold joining the cathode inlets of the fuel cell stack, and a resin tube was connected to the manifold joining the cathode fluid outlets. A resin tube was connected to the manifold joining the anode fluid outlets. The resin tube of the cathode fluid outlet and the resin tube of the anode fluid outlet were both introduced into a collection tank.

The collection tank was a rectangular resin container with a capacity of 100 mL. First, 50 mL of ion-exchange water was poured into the collection tank, and then the resin tube of the anode fluid outlet was inserted until it contacted the bottom of the collection tank, to allow the fluid discharged from the anode to flow into the liquid. The resin tube of the cathode fluid outlet was introduced into the upper portion of the collection tank, and the ceiling of the water collection tank was covered with a porous film.

A liquid feed hole was provided on the side surface of the collection tank at the lower most portion of the tank, and connected to a liquid feed pump, and the liquid feed pump was then connected to the manifold joining the anode inlets. To the collection tank, 10 mol/L methanol was supplied via a fuel pump from a fuel tank, to adjust the liquid in the collection tank to be an aqueous 1 mol/L methanol solution. A capacitive water level sensor was attached so as to sandwich opposing two side surfaces of the collection tank.

The water level sensor, fuel pump, and liquid feed pump were connected to an information processor serving as an operation control means, to allow the information processor to execute a control program as below.

When the liquid volume in the collection tank sensed by the water level sensor was below 30 mL, the flow rate of the fuel pump was increased and the flow rate of the liquid feed pump was decreased, to temporarily supply an aqueous fuel solution with high concentration to the anode. When the liquid volume was above 60 mL, the flow rate of the fuel pump was decreased and the flow rate of the liquid feed pump was increased, to temporarily supply an aqueous fuel solution with low concentration to the anode.

A direct oxidation fuel cell system of Example 2 was thus obtained. In this fuel cell system, cooperation of the information processor and the fuel pump and cooperation of the information processor and the liquid feed pump function as a collected fluid volume control means, and cooperate as a liquid volume control means for controlling the liquid volume in the collection tank. The information processor acts as a part of the liquid volume control means.

The volume of the anode-side space in this fuel cell system as measured from the liquid feed pump to the liquid in the collection tank was 15 mL.

### Example 3

A fuel cell stack was produced in the same manner as in Example 1. In addition, a cathode-side radiator and a cathode-side radiator cooling fan were used. Specifically, the manifold joining the cathode fluid outlets of the unit cells was connected to a radiator, using a resin tube. The cathode fluid discharged from the cathode was allowed to pass through the radiator and then flow into the collection tank.

The water level sensor and the radiator cooling fan were connected to an information processor serving as an operation control means, to allow the information processor to execute a control program in which: when the liquid volume in the collection tank was below 30 mL, the flow rate of the radiator cooling fan was increased; and when above 60 mL, the flow rate of the radiator cooling fan was decreased.

A direct oxidation fuel cell system of Example 3 was obtained in the same manner as in Example 2, except the above. In this fuel cell system, cooperation of the information processor and the radiator cooling fan constitutes a liquid volume control means.

The volume of the anode-side space in this fuel cell system as measured from the liquid feed pump to the liquid in the collection tank was 15 mL.

### Comparative Example 1

A fuel cell stack was produced in the same manner as in Example 1. The collection tank was not provided, and an aqueous fuel solution which had been prepared in advance was supplied to the anode. The resin tube connected to the manifold joining the anode fluid outlets was introduced into the waste liquid tank from above, whereby the end of the resin tube was open to the air. A direct oxidation fuel cell system of Comparative Example 1 was obtained in the same manner as in Example 1, except the above.

### Example 4

A fuel cell stack was produced in the same manner as in Example 1. A direct oxidation fuel cell system of Comparative Example 2 was obtained in the same manner as in Example 3, except for allowing the information processor to execute a control program in which: when the liquid volume in the collection tank was below 5 mL, the flow rate of the radiator cooling fan was increased; and when above 15 mL, the flow rate of the radiator cooling fan was decreased.

The volume of the anode-side space in this fuel cell system as measured from the liquid feed pump to the liquid in the collection tank was 15 mL.

### [Evaluation of Life Characteristics]

The obtained fuel cell systems of Examples 1 to 4 and Comparative Example 1 were subjected to the following normal operation, to evaluate the life characteristics thereof.

Air was supplied to the cathode of each unit cell, and an aqueous 1 mol/L methanol solution was supplied to the anode. The generation current was adjusted constant at 150 mA/cm² using an electronic load device. The temperature of the fuel cell was maintained at 60° C., the air utilization rate was set to 50%, and the fuel utilization rate was set to 70%. The power generation time was set for 60 minutes, which was followed by a rest time for 60 minutes. The above operation was regarded as one cycle, and 500 cycles were repeated in total. The ratio of an average output at the 500^{th} cycle to an average output at the 1^{st} cycle was calculated. The output retention rate thus calculated was evaluated as the life characteristics. The obtained results are shown in Table 1.

TABLE 1

| | | Range of liquid | | Output retention |
|---|---|---|---|---|
| | Component | volume in | | rate |
| | controlled | collection tank | | (%) |
| Ex. 1 | Drain | up to 50 | mL | 95 |
| Ex. 2 | Fuel pump | 30 to 60 | mL | 92 |
| | Liquid feed pump | | | |
| Ex. 3 | Radiator | 30 to 60 | mL | 95 |
| | Cooling fan | | | |
| Com. | None | 0 | mL | 53 |
| Ex. 1 | | | | |
| Ex. 4 | Radiator | 5 to 15 | mL | 58 |
| | Cooling fan | | | |

The fuel cells of Examples 1 to 3 in which the anode fluid was allowed to flow into the liquid in the collection tank, thereby to control the liquid volume in the collection tank to be greater than the volume of the anode-side space exhibited improved life characteristics, as compared with the fuel cell of Comparative Example 1 in which the anode fluid was open to the air. In Examples 1 to 3, during suspension of operation of the fuel cell, since the liquid in the collection tank including an aqueous fuel solution flowed into the anode, the intrusion of oxygen into the anode was suppressed, and the anode potential was kept constantly low. Presumably as a result, the deterioration of the anode was suppressed.

The life characteristic of Example 2 in which the flow rates of the fuel pump and the liquid feed pump were controlled to control the liquid volume in the collection tank was somewhat low. This is presumably because the above control causes the fuel concentration to increase temporarily, which increased MCO and facilitated the deterioration of the cathode.

The life characteristics of Example 1 and 3 were almost at the same level. It is to be noted that Example 1 was configured to discharge excess of the liquid in the collection tank through the drain, while Example 3 was configured not to discharge droplets from the fuel cell system. Therefore, Example 3 is more preferable in view of the convenience of the user.

The life characteristic of the fuel cell of Comparative Example 2 in which the liquid volume in the collection tank was controlled to be smaller than the volume of the anode-side space was improved as compared with that of Comparative Example 1, but it was a slight improvement. This is presumably because the volume of the liquid in the collection tank capable of flowing into the anode during suspension of operation was insufficient, and oxygen in the air entered the anode.

The foregoing results show that the present invention can provide a direct oxidation fuel cell system having improved life characteristics.

### Example 5

A direct oxidation fuel cell system was produced in the same manner as in Example 2. In this example, however, a lithium ion secondary battery was connected to the water level sensor, fuel pump, liquid feed pump, and information processor, so that these components were constantly supplied with power.

When the liquid volume in the collection tank sensed by the water level sensor during suspension of operation of the fuel cell system was below 20 mL, the auxiliary operation of the fuel cell system was automatically performed until the liquid volume exceeded 50 mL. In the auxiliary operation, the flow rates of the fuel pump and liquid feed pump were set higher than those recommended during normal operation, so that the amount of the excess of the aqueous fuel solution to be supplied to the fuel cell stack was increased.

The flow rate of the liquid feed pump in auxiliary operation was set to 3.0 mL/min, in view of the flow rate recommended in normal operation of 1.5 mL/min. The flow rate of the fuel pump in auxiliary operation was set to 0.6 mL/min, in view of the flow rate recommended in normal operation of 0.3 mL/min. The power generated by the fuel cell stack during auxiliary operation was charged to the lithium ion secondary battery. The control as above was executed by the information processor. In this way, a direct oxidation fuel cell system of Example 5 was obtained.

### Example 6

A direct oxidation fuel cell system was produced in the same manner as in Example 5. In this example, however, a cathode-side radiator and a cathode-side radiator cooling fan were used. Specifically, as in Example 3, the manifold joining the cathode fluid outlets of the unit cells was connected to the radiator, using a resin tube. The cathode fluid discharged from the cathode was allowed to pass through the radiator and then flow into the collection tank.

The water level sensor and radiator cooling fan were connected to the information processor serving as an operation control means, to allow the information processor to execute a control program as below.

When the liquid volume in the collection tank was below 20 mL, the auxiliary operation of the fuel cell system was automatically performed until the liquid volume exceeded 50 mL. In the auxiliary operation, instead of the flow rates of the fuel pump and liquid feed pump, the flow rate of the radiator cooling fan was set higher than that recommended in normal operation.

### Example 7

A direct oxidation fuel cell system was produced in the same manner as in Example 5. In this example, however, a stack cooling fan for cooling the fuel cell stack was provided, and the water level sensor and stack cooling fan were connected to the information processor, to control such that when the liquid volume in the collection tank was below 20 mL, the auxiliary operation of the fuel cell system was automatically performed until the liquid volume exceeded 50 mL. In the auxiliary operation, instead of the flow rates of the fuel pump and liquid feed pump, the flow rate of the stack cooling fan was set higher than that recommended in normal operation.

### Example 8

A direct oxidation fuel cell system was produced in the same manner as in Example 5. In the auxiliary operation in this example, however, the flow rate of the liquid feed pump was set to 1.2 mL/min, and the flow rate of the fuel pump was set to 0.8 mL/min.

### Comparative Example 2

A direct oxidation fuel cell system was produced in the same manner as in Example 5. In this example, however, the water level sensor was not provided, and the control to automatically perform an auxiliary operation on the basis of the liquid volume in the collection tank was not performed.

### Comparative Example 3

A direct oxidation fuel cell system was produced in the same manner as in Example 5. In this example, however, the water level sensor was not provided, and the control to automatically perform an auxiliary operation on the basis of the liquid volume in the collection tank was not performed. In addition, an electronic valve was disposed at the ceiling portion of the collection tank and at the cathode fluid outlet, and the valves were connected to the information processor, to control each value to be closed when the operation was stopped. In this mechanism, the fuel cell stack and the collection tank are sealed after the operation is stopped. However, in order to prevent these from being completely sealed, the valves had been provided with a very small opening.

### [Evaluation of Life Characteristics]

The obtained fuel cell systems of Examples 5 to 8 and Comparative Examples 2 and 3 were subjected to the following evaluation.

(i) First, the normal operation of each fuel cell system was performed. At this time, air was supplied to the cathode of each unit cell, and an aqueous 1 mol/L methanol solution was supplied to the anode. The generation current was adjusted constant at 150 mA/cm². The temperature of the fuel cell was maintained at 60° C., the air utilization rate was set to 50%, and the fuel utilization rate was set to 70%. The power generation time was set for 60 minutes.

(ii) Next, the fuel cell system was placed in a well-ventilated room with the temperature kept at 45° C., and left standing for 1 month while the power generation of the fuel cell was suspended, without being shielded with, for example, an outer box or a cover. The liquid volume in the collection tank after left standing was measured.

(iii) Thereafter, the fuel cell system after left standing was operated under the same operation conditions as those for the initial fuel cell system. The ratio of the generated voltage after left standing to the initial generated voltage was calculated, to see the changes in the power generation characteristics.

The results are shown in Table 2.

TABLE 2

| | Prevention | | Liquid volume in | Generated |
|---|---|---|---|---|
| | means for | | collection tank | voltage |
| | liquid | Component | after left standing | rate |
| | dissipation | controlled | (mL) | (%) |
| Ex. 5 | Auxiliary | Fuel pump | 38 | 95 |
| | operation | Liquid feed pump | | |
| Ex. 6 | Auxiliary | Radiator cooling | 42 | 99 |
| | operation | fan | | |
| Ex. 7 | Auxiliary | Stack cooling fan | 34 | 97 |
| | operation | | | |
| Ex. 8 | Auxiliary | Fuel pump | 36 | 94 |
| | operation | Liquid feed pump | | |
| Com. | None | None | 0 | Power |
| Ex. 2 | | | | generation |
| | | | | impossible |
| Com. | Valve | None | 4 | 72 |
| Ex. 3 | | | | |

In the fuel cell systems of Examples 5 to 8 controlled such that when the liquid volume in the collection tank was below a predetermined value (second lower-limit value), the auxiliary operation of the fuel cell system was automatically performed for a certain period of time, thereby to increase the volume of the liquid in the collection tank, a sufficient amount of liquid remained in the collection tank even after left standing for 1 month. This allowed the fuel cell system to be activated without problem even after left standing for 1 month, and to maintain similar level of good power generation characteristics to that before left standing.

On the other hand, in the fuel cell system of Comparative Example 1 which was not provided with a means for preventing dissipation of liquid held in the collection tank, no liquid remained in the collection tank after left standing for 1 month. As a result, when the fuel cell system after left standing was activated, an aqueous fuel solution with high concentration was supplied to the anode, and the generated voltage was significantly reduced. Therefore, in order to protect the fuel cell stack, the activation was stopped.

In the fuel cell system of Comparative Example 2 in which the collection tank and the fuel cell stack were sealed with a valve in order to suppress dissipation of liquid held in the collection tank, only a small amount of liquid remained in the collection tank after left standing for 1 month. As such, when the fuel cell system after left standing was activated, an aqueous fuel solution whose concentration was higher than usual was supplied, and the generated voltage was reduced.

In Examples 5 to 8, although the components controlled by the operation control means in order to increase the collected volume of liquids are different, the dissipation of liquid held in the collection tank was suppressed. The foregoing results show that the present invention can provide a direct oxidation fuel cell system capable of suppressing dissipation of water from the fuel cell system even if stored for a long period of time, being activated without problem after storage, and exhibiting similar level of good power generation characteristics to that before storage.

### INDUSTRIAL APPLICABILITY

According to the present invention, the life characteristics and the reliability for long-term storage of direct oxidation fuel cell systems can be improved. Therefore, the present invention can provide a direct oxidation fuel cell system capable of maintaining excellent power generation characteristics over a long period of time and exhibiting stable performance, even after continuous use including long-term storage. The direct oxidation fuel cell system of the present invention is very useful as a power source for small-size equipment such as notebook personal computers, and a portable power generator.

### REFERENCE SIGNS LIST

1: Unit cell, 2: Anode, 3: Cathode, 4: Electrolyte membrane, 5: Membrane electrode assembly (MEA), 6: Anode catalyst layer, 7: Anode diffusion layer, 8: Cathode catalyst layer, 9: Cathode diffusion layer, 10: Anode-side separator, 11: Cathode-side separator, 12: Fuel flow channel, 13: Oxidant flow channel, 14 and 15: Gasket, 16 and 17: Current collector plates, 18 and 19: End plates, 20: Collection tank, 21: Liquid, 22: Drain, 23: Fuel pump, 24: Air pump, 25: Liquid feed pump, 26: Fuel tank, 27: Liquid volume sensing means, 28: Operation control means (information processor), 29: Radiator

1-10. (canceled)

11. A direct oxidation fuel cell system comprising
a direct oxidation fuel cell including an anode and a cathode,
an air pump for supplying air to the cathode,
a liquid feed pump for supplying an aqueous fuel solution to the anode, and
a collection tank for collecting an anode fluid discharged from the anode, wherein:
the collection tank has an anode fluid collection port at which the anode fluid is merged with a liquid in the collection tank;
either during normal operation or during suspension of operation of the fuel cell system, or both, a volume of the liquid in the collection tank is controlled to be equal to or greater than a predetermined first lower-limit value, the first lower-limit value being set such that the anode fluid collection port is positioned below a level of the liquid in the collection tank; and
when the volume of the liquid in the collection tank is equal to the first lower-limit value, a volume of the liquid present above the anode fluid collection port is greater than a volume of an anode-side space extending from the liquid feed pump via the anode to the anode fluid collection port in the liquid in the collection tank.

12. The direct oxidation fuel cell system according to claim 11, wherein during suspension of operation of the fuel cell system, when the volume of the liquid in the collection tank reaches the first lower-limit value, an auxiliary operation is automatically performed for a certain period of time.

13. The direct oxidation fuel cell system according to claim 11, wherein during suspension of operation of the fuel cell system, when the volume of the liquid in the collection tank reaches a second lower-limit value different from the first lower-limit value, an auxiliary operation is automatically performed for a certain period of time.

14. The direct oxidation fuel cell system according to claim 11, further comprising:
a liquid volume sensing means for sensing the liquid volume in the collection tank, and
an operation control means for controlling an operating state of the fuel cell system, wherein
the operation control means controls a normal operating state of the fuel cell system on the basis of the liquid volume sensed by the liquid volume sensing means, thereby to control the volume of the liquid in the collection tank.

15. The direct oxidation fuel cell system according to claim 12, further comprising:
a liquid volume sensing means for sensing the liquid volume in the collection tank, and
an operation control means for controlling an operating state of the fuel cell system, wherein
the operation control means controls an auxiliary-operating state of the fuel cell system on the basis of the liquid volume sensed by the liquid volume sensing means, thereby to control the volume of the liquid in the collection tank.

16. The direct oxidation fuel cell system according to claim 14, wherein the operation control means controls, on the basis of the liquid volume sensed by the liquid volume sensing means, at least one selected from the group consisting of: electric power generated by the fuel cell, output of the air pump, and output of the liquid feed pump.

17. The direct oxidation fuel cell system according to claim 11, wherein when the volume of the liquid in the collection tank falls below the first lower-limit value during normal operation of the fuel cell system, a warning for urging replenishment of water to the collection tank is outputted.

18. The direct oxidation fuel cell system according to claim 12, wherein when the volume of the liquid in the collection tank is below the first lower-limit value after the auxiliary operation for a certain period of time of the fuel cell system, a warning for urging replenishment of water to the collection tank is outputted.

19. The direct oxidation fuel cell system according to claim 13, wherein when the volume of the liquid in the collection tank is below the second lower-limit value after the auxiliary operation for a certain period of time of the fuel cell system, a warning for urging replenishment of water to the collection tank is outputted.

20. The direct oxidation fuel cell system according to claim 14, further comprising (i) a combination of a fuel tank for accommodating fuel to be mixed with the liquid in the collection tank, and a fuel pump for supplying the fuel from the fuel tank to the liquid, wherein the operation control means controls output of the fuel pump, on the basis of the liquid volume sensed by the liquid volume sensing means.

21. The direct oxidation fuel cell system according to claim 14, further comprising (ii) a combination of an anode-side radiator through which the anode fluid passes, and an anode-side radiator cooling fan for cooling the anode-side radiator, wherein the operation control means controls output of the anode-side radiator cooling fan, on the basis of the liquid volume sensed by the liquid volume sensing means.

22. The direct oxidation fuel cell system according to claim 14, further comprising (iii) a combination of a cathode fluid collection port being configured to collect at least part of a cathode fluid discharged from the cathode and being provided in the collection tank, a cathode-side radiator through which the cathode fluid passes, and a cathode-side radiator cooling fan for cooling the cathode-side radiator, wherein the operation control means controls output of the cathode-side radiator cooling fan, on the basis of the liquid volume sensed by the liquid volume sensing means.

23. The direct oxidation fuel cell system according to claim 14, further comprising (iv) a stack cooling fan for cooling the fuel cell, wherein the operation control means controls output of the stack cooling fan, on the basis of the liquid volume sensed by the liquid volume sensing means.

24. A direct oxidation fuel cell system comprising
a direct oxidation fuel cell including an anode and a cathode,
an air pump for supplying air to the cathode,
a liquid feed pump for supplying an aqueous fuel solution to the anode, and
a collection tank for collecting an anode fluid discharged from the anode, wherein:
the collection tank has an anode fluid collection port at which the anode fluid is merged with a liquid in the collection tank; and
during suspension of operation of the fuel cell system, when the volume of the liquid in the collection tank reaches a predetermined first lower-limit value, an auxiliary operation is automatically performed for a certain period of time, the first lower-limit value being set such that the anode fluid collection port is positioned below a level of the liquid in the collection tank.

25. The direct oxidation fuel cell system according to claim 13, further comprising:
a liquid volume sensing means for sensing the liquid volume in the collection tank, and
an operation control means for controlling an operating state of the fuel cell system, wherein
the operation control means controls an auxiliary-operating state of the fuel cell system on the basis of the liquid volume sensed by the liquid volume sensing means, thereby to control the volume of the liquid in the collection tank.

26. The direct oxidation fuel cell system according to claim 15, wherein the operation control means controls, on the basis of the liquid volume sensed by the liquid volume sensing means, at least one selected from the group consisting of: electric power generated by the fuel cell, output of the air pump, and output of the liquid feed pump.

27. The direct oxidation fuel cell system according to claim 25, wherein the operation control means controls, on the basis of the liquid volume sensed by the liquid volume sensing means, at least one selected from the group consisting of: electric power generated by the fuel cell, output of the air pump, and output of the liquid feed pump.

28. The direct oxidation fuel cell system according to claim 15, further comprising (i) a combination of a fuel tank for accommodating fuel to be mixed with the liquid in the collection tank, and a fuel pump for supplying the fuel from the fuel tank to the liquid, wherein the operation control means controls output of the fuel pump, on the basis of the liquid volume sensed by the liquid volume sensing means.

29. The direct oxidation fuel cell system according to claim 15, further comprising (ii) a combination of an anode-side radiator through which the anode fluid passes, and an anode-side radiator cooling fan for cooling the anode-side radiator, wherein the operation control means controls output of the anode-side radiator cooling fan, on the basis of the liquid volume sensed by the liquid volume sensing means.

30. The direct oxidation fuel cell system according to claim 15, further comprising (iii) a combination of a cathode fluid collection port being configured to collect at least part of a cathode fluid discharged from the cathode and being provided in the collection tank, a cathode-side radiator through which the cathode fluid passes, and a cathode-side radiator cooling fan for cooling the cathode-side radiator, wherein the operation control means controls output of the cathode-side radiator cooling fan, on the basis of the liquid volume sensed by the liquid volume sensing means.

31. The direct oxidation fuel cell system according to claim 15, further comprising (iv) a stack cooling fan for cooling the fuel cell, wherein the operation control means controls output of the stack cooling fan, on the basis of the liquid volume sensed by the liquid volume sensing means.

32. The direct oxidation fuel cell system according to claim 25, further comprising (i) a combination of a fuel tank for accommodating fuel to be mixed with the liquid in the collection tank, and a fuel pump for supplying the fuel from the fuel tank to the liquid, wherein the operation control means controls output of the fuel pump, on the basis of the liquid volume sensed by the liquid volume sensing means.

33. The direct oxidation fuel cell system according to claim 25, further comprising (ii) a combination of an anode-side radiator through which the anode fluid passes, and an anode-side radiator cooling fan for cooling the anode-side radiator, wherein the operation control means controls output of the anode-side radiator cooling fan, on the basis of the liquid volume sensed by the liquid volume sensing means.

34. The direct oxidation fuel cell system according to claim 25, further comprising (iii) a combination of a cathode fluid collection port being configured to collect at least part of a cathode fluid discharged from the cathode and being provided in the collection tank, a cathode-side radiator through which the cathode fluid passes, and a cathode-side radiator cooling fan for cooling the cathode-side radiator, wherein the operation control means controls output of the cathode-side radiator cooling fan, on the basis of the liquid volume sensed by the liquid volume sensing means.

35. The direct oxidation fuel cell system according to claim 25, further comprising (iv) a stack cooling fan for cooling the fuel cell, wherein the operation control means controls output of the stack cooling fan, on the basis of the liquid volume sensed by the liquid volume sensing means.
